(19) United States
(12) Patent Application Publication
(10) Pub. No.: US 2007/0258346 A1
(43) Pub. Date: Nov. 8, 2007

(54) PC PERIPHERAL DEVICES USED WITH MOBILE MEDIA DEVICES

(75) Inventors: Timothy Bucher, Mountain View, CA (US); Mark Andrew Ross, San Carlos, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: ZING SYSTEMS, INC., Mountain View, CA (US)

(21) Appl. No.: 11/739,560

(22) Filed: Apr. 24, 2007

Related U.S. Application Data
(60) Provisional application No. 60/796,821, filed on May 2, 2006.

(51) Int. Cl. G11B 7/00

(52) U.S. Cl. 369/116

(57) ABSTRACT

A personal media managing system includes a portable media device that interfaces with a peripheral media device. When in communication, media content is transferred between the devices such that the peripheral media device serves as a redundant backup of data from the portable media device and as a repository of data to be uploaded to the portable media device. Among other things, the portable media device may include: an interactive control display; memory for storing media; and a media player module configured for playing selected media for a user. Additionally, among other things the peripheral media device may include: systems for uploading selected media from a media source; a content management system; and a mass storage device for storing media.

### CROSS-REFERENCE TO RELATED APPLICATIONS

This application claims the benefit of U.S. Provisional Patent Application Ser. No. 60/796,821 filed May 2, 2006, which application is incorporated herein by reference in its entirety.

### BACKGROUND OF THE INVENTION

1. The Field of the Invention

The present invention relates generally to the fields of portable media devices and computing devices. More particularly, the invention relates to systems and methods for a portable media device to use a peripheral computing device to extend its storage and its connectivity and to provide other features not conventionally available in small portable media devices.

2. The Relevant Technology

Numerous forms of personal portable media devices are proliferating today. One example is satellite radio, or Digital Audio Radio Service (DARS), which is the broadcast of digital audio programming via satellites directly to users. Through satellite radio, subscribers can receive high quality, uninterrupted, digital data such as radio over more than one hundred radio channels, for example digital quality music, talk radio, sports, news, weather, and the like. Often, a user of satellite radio has a small portable device they use to receive the digital data stream. Other examples of portable media players are digital audio devices, often referred to as MP3 players, portable CD players, digital video players, portable game consoles, portable DVD players, notebook computers, and the like.

The growth in portable device technology corresponds with a growth in wireless network technology and the ability to distribute digital media. As a result, digital media is readily uploaded from CDs, downloaded from the Internet, and received over wireless networks that include, for example: IP based networks, radio networks, cellular networks, and WiFi networks.

Digital media can also be enjoyed on non-portable or less-portable devices, and in fact such devices often have significant advantages over portable media devices. Such devices include, for example, desktop and notebook computers, which are not as limited by space or mobility constraints. As a result, non-portable and less-portable devices typically have faster and more reliable Internet access, more continuous Internet access, greater storage capacity, integrated optical drives, and greater expandability.

Accordingly, regardless of the type of portable media device, whether a satellite radio receiver, a digital audio device, a PDA, or the like, it is often desirable for the device to have many of the features of a larger and less portable device, for example greater storage capacity and greater connectivity, that are not available in conventional small portable devices. It is therefore desirable to have improved designs for portable media devices that afford many of the advantages of less-portable devices.

### BRIEF SUMMARY OF THE INVENTION

The present invention relates to a portable media player. The inventive systems include a small portable media device that interfaces with a larger peripheral media device. The devices may interface by docking such that media content or other data can be automatically transferred between the devices as directed by a user or an automated system.

Accordingly, a first example embodiment of the invention is a personal media managing system. The system includes a portable media device and a peripheral media device. The portable media device generally includes: an interactive control display; memory for storing media; and a media player module, such as for example a satellite radio receiver, configured for playing selected media for a user. The peripheral media device is configured for removable connectivity with the portable media device and generally includes: a content management system for coordinating the upload to the peripheral media device of selected media from a media source and the upload to the portable media device of selected media from the peripheral media device; and a mass storage device serving as a redundant backup of media from the portable media device and as a repository of media not currently stored on the portable media device.

A second example embodiment of the invention is also a personal media managing system having a portable media device and a peripheral media device. The portable media device generally includes: a first dock member; an interactive control display; memory for storing media; and a media player module configured for playing selected media to a user. The peripheral media device generally includes: a content management system for coordinating the upload to the peripheral media device of selected media from a media source and the upload to the portable media device of selected media from the peripheral media device; a second dock member for receiving the first dock member, wherein connecting the first dock member to the second dock member activates the personal media managing system such that automated data transfer is initiated; and a mass storage device serving as a redundant backup of media from the portable media device and as a repository of media not currently stored on the portable media device.

Embodiments of the invention can include an optical drive that is configured to automatically read media stored on optical media inserted into the optical drive bay and store the read media to the mass storage device.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a media player system according to one embodiment of the invention;

FIG. 2 illustrates a user interface on a display of a portable media device according to another embodiment of the invention;

FIG. 3 illustrates connectivity between a portable media player and a peripheral media device according to another embodiment of the invention;

FIG. 4 illustrates features of a portable media player according to another embodiment of the invention;

FIG. 5 illustrates features of a peripheral media device according to another embodiment of the invention;

FIG. 6 illustrates connectivity between a media player system and a personal computer;

FIG. 7 illustrates a screen shot of one embodiment of a user interface;

FIGS. 8A and 8B illustrate perspective views of an embodiment of a media device and a docking station that allows media to be copied or ripped to the media device; and

FIGS. 9A and 9B illustrate other embodiments of a personal media device such as a satellite radio device that can interface with a docking station such as a personal computer or with a system capable of performing media stored on a satellite radio or received through a satellite radio media device.

### DETAILED DESCRIPTION OF THE PREFERRED EMBODIMENTS

Reference will now be made to the figures wherein like structures will be provided with like reference designations. It is understood that the drawings are diagrammatic and schematic representations of presently preferred embodiments of the invention, and are not limiting of the present invention nor are they necessarily drawn to scale.

In the following description, numerous specific details are set forth in order to provide a thorough understanding of the present invention. It will be obvious, however, to one skilled in the art that the present invention may be practiced without these specific details. In other instances, well-known aspects of computing and media player systems have not been described in particular detail in order to avoid unnecessarily obscuring the present invention.

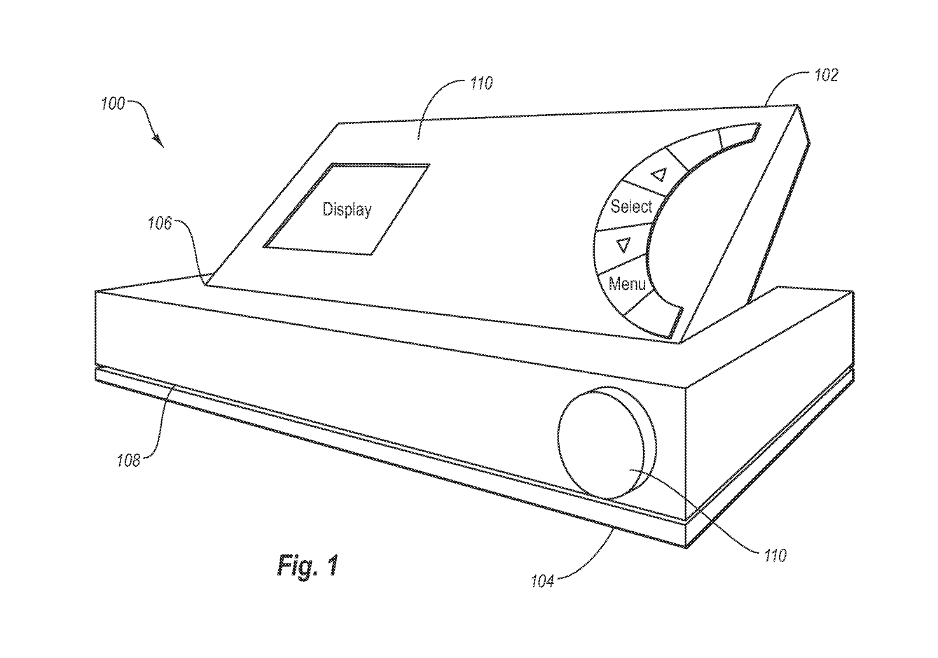

The present invention includes a peripheral media personal computing system 100, as illustrated in FIG. 1. The system 100 includes a portable media device 102 that interfaces with a peripheral media personal computing device 104, also referred to herein as a peripheral media device. As illustrated, the portable media device 102 can be docked in a docking station 106 of peripheral media device 104. In the depicted embodiment of the invention, the peripheral media device 104 also has an optical drive bay 108 and a volume control 110. The illustrated portable media device 102, in turn, has a user interface 110 such as a touch pad display that is configured for providing all the control necessary to operate the peripheral media device 104 as described herein below.

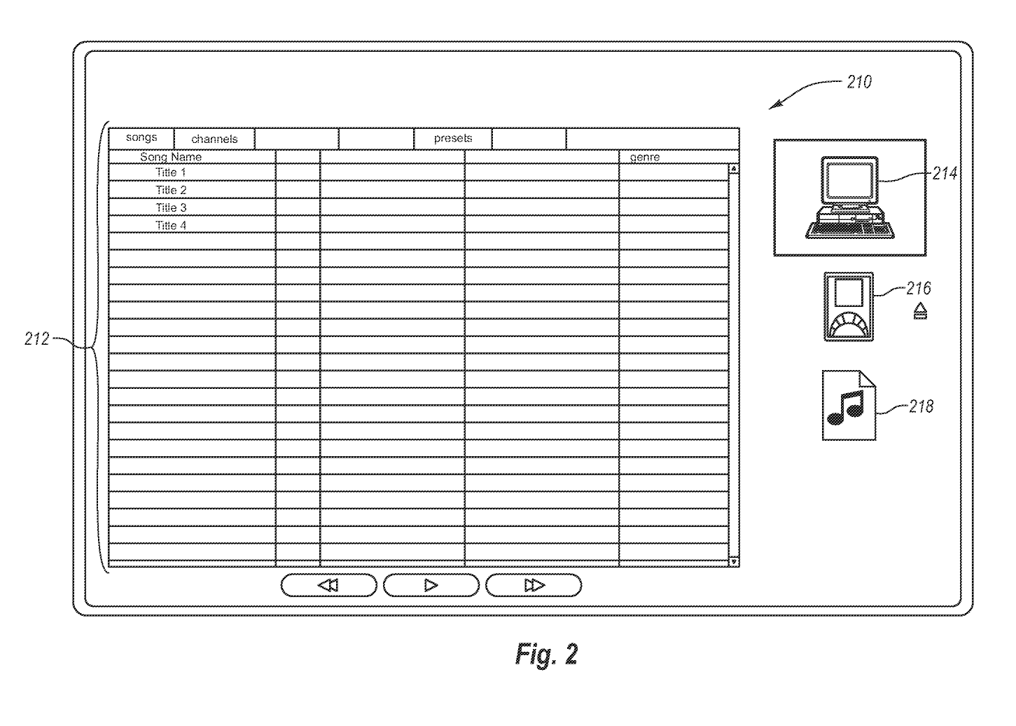

FIG. 2 illustrates an embodiment of a user interface display 210 for managing media. Although the display 210 will typically be used on a portable media device such as the device 102, a monitor or other display device can be connected to a peripheral media device such as the device 104 to present the display. User interface display 210 can include various methods of managing media on the device, for example by providing a listing of songs depicted in section 212 that are stored on a peripheral media device. In this example, a highlighted icon 214 representative of a peripheral media device denotes that the viewed media are stored on the peripheral media device. A portable media device icon 216, in turn indicates a touch point the user can select to see a listing of content on the portable media device. Play list icon 118, in turn, denotes a touch point where the user can select to see and modify play lists. Other controls can also be used, including any number of touch screen programmed controls on the display. The operation of the touch screen can be enhanced with audio noises or vibrations to indicate certain actions or occurrences, for example click noises to indicate that a button has been activated. In addition to or in place of a touch-screen display, other methods and/or devices of user input can be implemented, including, but not limited to, buttons, wheels, capacitive devices, standard keyboards and/or mice.

In one embodiment, a peripheral media device can have an operating system similar to conventional computing systems operating on the Windows® or Linux® operating systems. In this embodiment, a content management system application runs on top of the operating system of the peripheral media device to coordinate data transfer with the portable media device, manage media, and control other operations of the invention as desired.

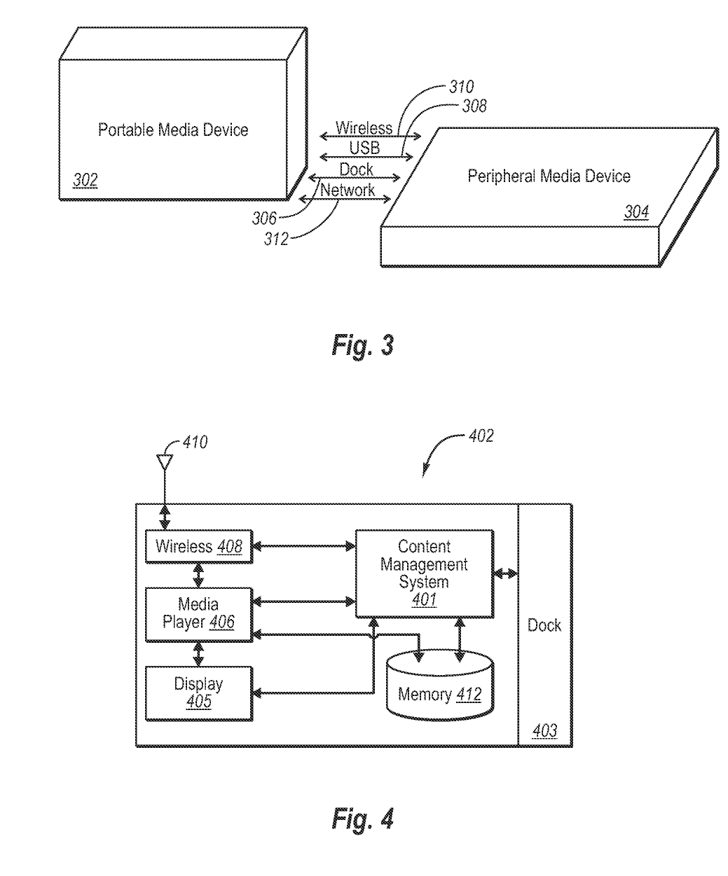

Turning now to FIG. 3, various means for communicating are depicted between a portable media device 302 and a peripheral media device 304. The portable media device 302 and the peripheral media device 304 may correspond, in one embodiment, to the devices 102 and 104 of FIG. 1, respectively. Furthermore, any one or more of the illustrated communication means may be provided between the two devices 302 and 304.

As previously discussed, a docking system can be used to provide connectivity between the devices, as indicated by arrow 306. The docking system is advantageous in that it provides a secure base for the portable media device 302 and also provides fast direct contact points for data transfer. In the event that portable media device 302 uses a rechargeable battery system, the dock can also provide a power source for recharging.

The devices can also communicate by a conventional USB cable, as indicated by arrow 308. USB devices have the advantage of being widely used in that almost all computers currently manufactured have several USB ports. In this case, a conventional computer having its own display and optionally input devices can be equipped with the appropriate software to run the peripheral media application and communicate with the peripheral media device 304. Other cable connection systems can of course also be used.

In addition, wireless connectivity between portable media device 302 and peripheral media device 304 can be used. One non limiting example standard is the 802.11g wireless standard, although other wireless connections can also be used, as indicated by arrow 310. Docking functions as described herein, such as for example data transfer, can take place wirelessly when the portable media device 302 is in range of the 802.11g router and each device 302, 304 is powered on. Advantageously, this enables the two devices 302 and 304 to transfer data without being physically coupled (e.g., via dock or USB cable) as required for conventional portable media devices. Finally, connectivity between the portable media device 302 and peripheral media device 304 can be obtained through network or Internet connections as indicated by arrow 312.

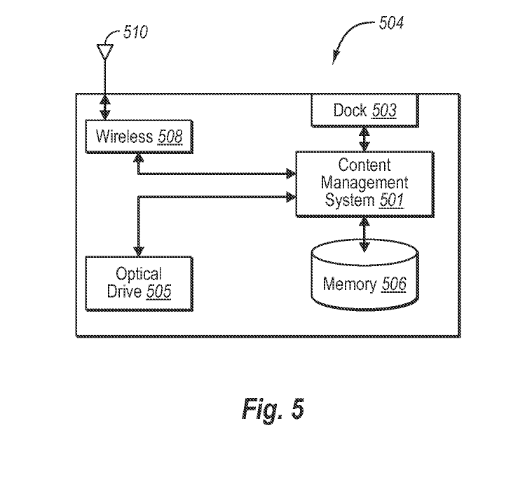

Referring now to FIGS. 4 and 5, example features, modules and systems of a portable media device 402 and a peripheral media device 504 are depicted in block form and described in greater detail. The depicted embodiment of a portable media device 402 includes numerous modules or components used in managing media, playing media, communicating with and controlling a peripheral media device 504, and wirelessly communicating with other devices or networks. As previously mentioned, other features, modules and systems of the portable media device 402 and the peripheral media device 504 are omitted to avoid obscuring the invention.

Initially, each of portable media device 402 and peripheral media device 504 include a content management system, labeled 401 and 501 respectively. By way of example, the content management systems 401 and 501 are used to coordinate the transfer of data between the devices as well as to manage the storage, organization, and play of media and other content. The content management system 401 on the portable media device 402 may be generally geared towards the user interface and media play aspects of the invention whereas the content management system 501 on the peripheral media device 504 may be geared towards content storage and media uploading from the Internet or media such as optical media inserted to optical drive 505.

Portable media device 402 optionally includes a dock member 403 for interfacing with an optional dock member 503 on peripheral media device 504. Connecting the dock member 403 to the dock member 503 can serve as a mechanism for many advantages of the present system. For example, peripheral media device 504 can be left in a power save mode where it is normally inactive. Inserting the portable media device 402 in the dock port 503 of the peripheral media device 504 can serve to turn on the peripheral media device 504 and commence a synchronization of data between the devices. For example, a user operating the control display 405 on the portable media device 402 may have previously changed preferences or made synchronization commands that affect what media is stored on the portable media device 402 and what media is stored on the peripheral media device 504. Docking the portable media device 402 can serve to initiate the planned media transfer between the devices to make the changes. In addition, the peripheral media device 504 can be directed to download from the Internet various content including, podcasts, voice messages, audio books, music, video or the like when the devices are not connected. That data can be transferred upon docking if desired. In another example, if an entire audio or video file cannot be stored on the portable media device 402, each docking can be used to automatically remove the previously listened to or viewed portion of the media file and upload the next portion of the media file or files.

In addition, the devices can be configured so that a rechargeable power source in portable media device 402 is recharged automatically by peripheral media device 504 each time it is docked.

Portable media device 402 also includes controls for a touch display 405, which may correspond to the display 110 of FIG. 1. As seen in FIG. 1, the display can fill almost one entire side of the portable media device 102 so that a maximized user interface is provided. Further details regarding the interface aspects of display 405 are provided hereinabove with the discussion of FIG. 2. In addition to being a touch screen control system, display 405 can also be used to view video or see still images or manage other aspects of the peripheral media device 504.

Other user input systems can also be added, including for example a physical or digital switch or channel dial. Input ports, such as USB or game ports, can also be included on the portable media device in various embodiments of the invention.

Portable media device 402 further includes one or more media player modules or systems 406. By way of example only, such a module or system 406 may be a portable satellite radio receiver. In addition to or instead of a satellite radio receiver, the device can have a media player device, such as for example a digital audio player such as an MP3 player, a PDA having media capability, or a portable DVD player, or other video source. Memory device 412 is used to store media and other data that is uploaded to the portable media device 402.

The satellite radio receiver may also have a channel determination module as described in U.S. patent application Ser. No. 11/177,823, filed Jul. 8, 2005 and entitled CHANNEL MAPPING FOR MOBILE MEDIA CONTENT TRANSMISSION, which is incorporated herein by reference.

In addition, each of the portable media device 402 and the peripheral media device 504 may also include wireless modules and systems 408, 508 with antenna 410, 510 for receiving wireless signals, including satellite radio signals, and/or for transmitting signals. While depicted as a single antenna, those skilled in the art will recognize that multiple antennas may be used, one for each distinct type of radio signal. The wireless systems 408, 508 may also include systems necessary to communicate wirelessly between the peripheral media device 504 and the portable media device 402 as indicated in FIG. 3. Specific components, such as those necessary to operate a satellite radio device and communicate wirelessly between devices, are not depicted to avoid unnecessarily obscuring the invention. The inclusion of such systems, however, will be apparent to one skilled in the art in view of the disclosure herein.

In one embodiment of the invention, one or both devices 402, 504 include systems and modules necessary to monitor and store content received simultaneously over several radio or satellite channels. Such monitoring of multiple channels is described in detail in U.S. patent application Ser. No. 11/193,828, filed Jul. 29, 2005 and entitled VIRTUAL DISCOVERY OF CONTENT AVAILABLE TO A DEVICE, which is incorporated herein by reference.

Finally, portable media device 402 includes some device for communicating audio to a user. This can be in the form of speakers or headphones. Speakers can be integrated in the portable media device 402 or connected with wires or wirelessly. Similarly, headphones can also be connected to the portable media device 402 with wires or wirelessly.

With reference now to FIG. 5, as previously indicated the peripheral media device 504 also may include an optical drive 505. Having an optical drive 505 in the peripheral media device 504 is particularly advantageous in that such a device can be omitted from the portable media player 402 to conserve space. In one embodiment, the optical drive can be managed by the content management system 501 so that an optical disk inserted into the optical drive 505 is automatically ripped, or copied, to the storage device 506. The storage device 506 may be a mass storage device where large amounts of media content such as CD or DVD content can be stored. The auto ripping feature of the optical drive helps a user quickly consolidate and manage their media content in as efficient a manner as possible. Other types of storage are also contemplated by embodiments of the invention, including holographic storage.

Although the peripheral media device 504 may lack a control mechanism other than portable media player 402 in order to conserve cost and space, other user input and display systems can be added. This can be accomplished with USB ports or other ports on the peripheral media device 504 where a keyboard, mouse, monitor or other device can be quickly added in a plug and play fashion. Other user input systems can also be added, including for example a physical or digital switch or channel dial, such as for example a volume control. In another aspect of the invention, the portable media device can serve as the principal display device for the peripheral media device 504 when it is acting as a computer, for example as a web browser or DVD player. Thus, for example, the portable media device 402 can serve as a display while a movie on DVD is operated from optical drive 505.

According to yet another aspect of the invention, peripheral media device 504 can have systems and devices, including wireless systems and modules 508, 510, to serve as a multicasting router for content sharing. Content sharing by wireless multicasting is described in detail in U.S. patent application Ser. No. 11/356,131, filed Feb. 16, 2006 and entitled LOCAL TRANSMISSION FOR CONTENT SHARING, which is incorporated herein by reference. Generally, wireless multicasting allows a user operating a handheld media device to wirelessly share content from their device to additional users. Conventional systems only allow a user to transmit content to the headphones of the user operating the handheld media device. Multicasting allows the user to securely transmit content to additional devices or headphones leveraging the power and bandwidth of a router. The transmission of content can occur in either a secure mode or in an unsecure mode.

In one method of the invention, upon connecting the portable media device 402 to the peripheral media device 504, either wirelessly, by docking, or by another method, data is synchronized between the devices 402, 504 based upon user input to the portable media device 402, automated updates to the peripheral media device 504, and other settings such as automated removal from the portable media device 402 of listened-to or seen content and the addition of not-listened-to or unseen content.

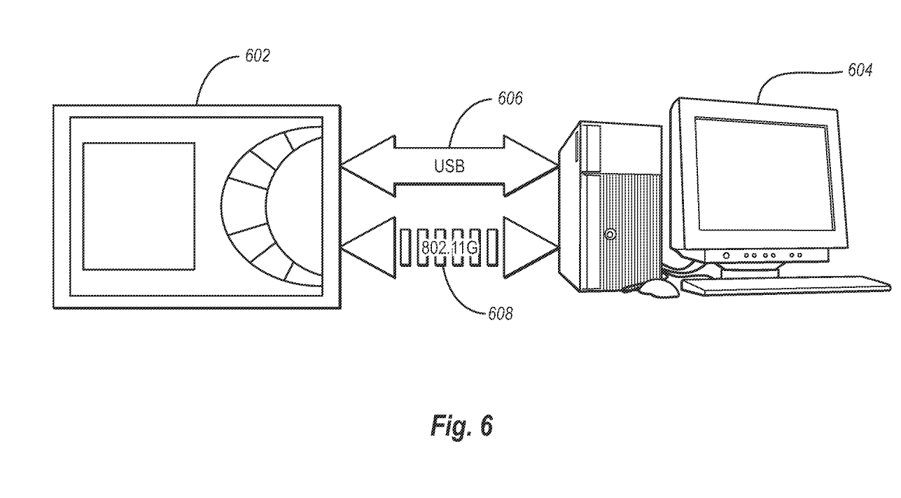

FIGS. 6 through 9B show example illustrations of a satellite radio or other device and the ability to interface with stereo equipment, media readers (such as CD-ROM devices, personal computers, and the like), as well as user interfaces associated with the media device. FIG. 6, for example, illustrates a device 602, which is one embodiment of the device 102 in FIG. 1, that can interface with a computer 604 over various wired (e.g., USB) or wireless (e.g., 802.11g) connections 606, 608. These connections are given by way of example only and are not limiting of the wired and/or wireless connections that can be used to communicate between the devices.

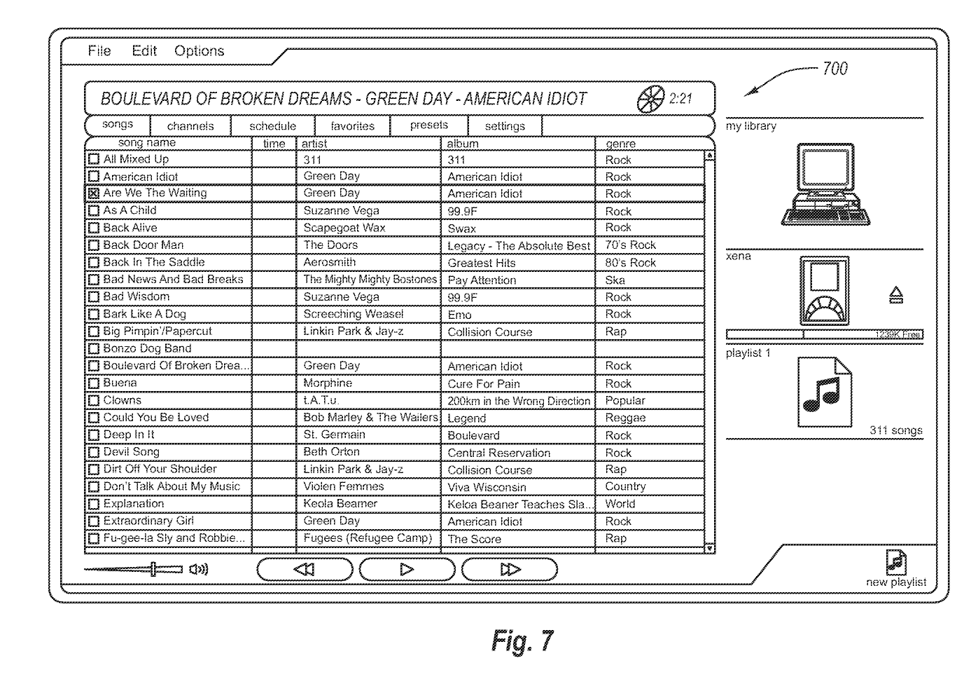

FIG. 7 illustrates one embodiment of a user interface that illustrates song lists that are stored on the portable media device 602, for example. The user interface 700 may correspond to the user interface display 210 of FIG. 2. FIG. 7 illustrates icons that can be used to manipulate the media on the portable media device 602. In one embodiment, the media represented in the user interface 700 has been recorded from a satellite radio broadcast. A user has the option of transferring the content to a computer, purchasing the content, and the like. When purchasing, a single click is all that is needed to purchase the content and download a high quality version to the user's computer or to the portable media device 602.

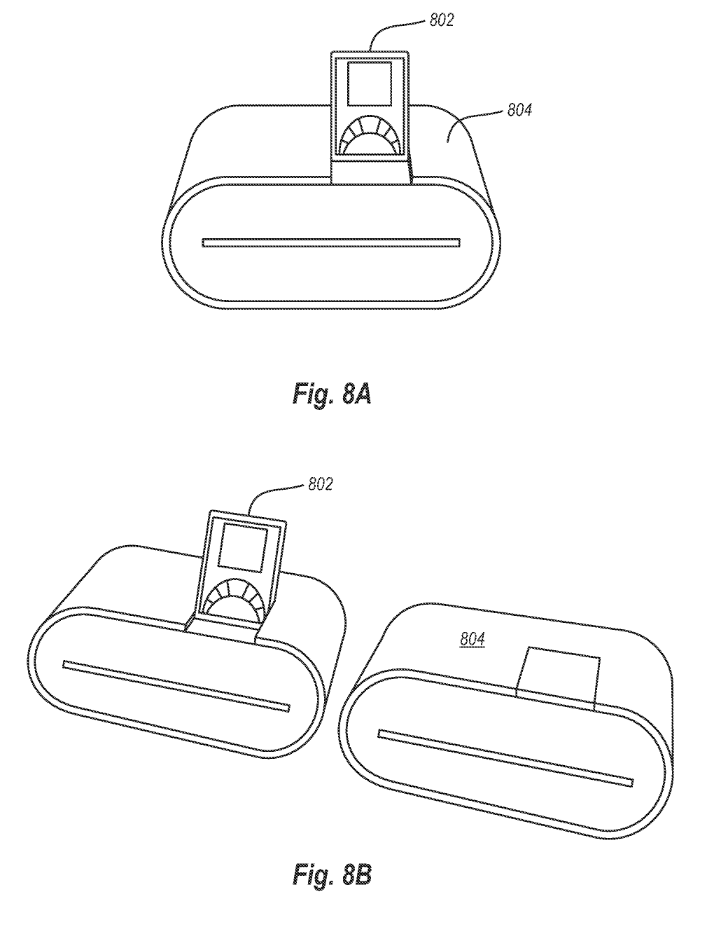

FIGS. 8A and 8B illustrate embodiments of a portable media device 802 (which may correspond to the device 102 of FIG. 1) that can interact with a peripheral media device 804. In this example, the peripheral media device 804 is a device capable of reading CD-ROMs, DVD-ROMs, etc. A user has the option of loading content onto the portable media device 802 directly from the peripheral media device 804 without having to go through an intermediary personal computer in one embodiment.

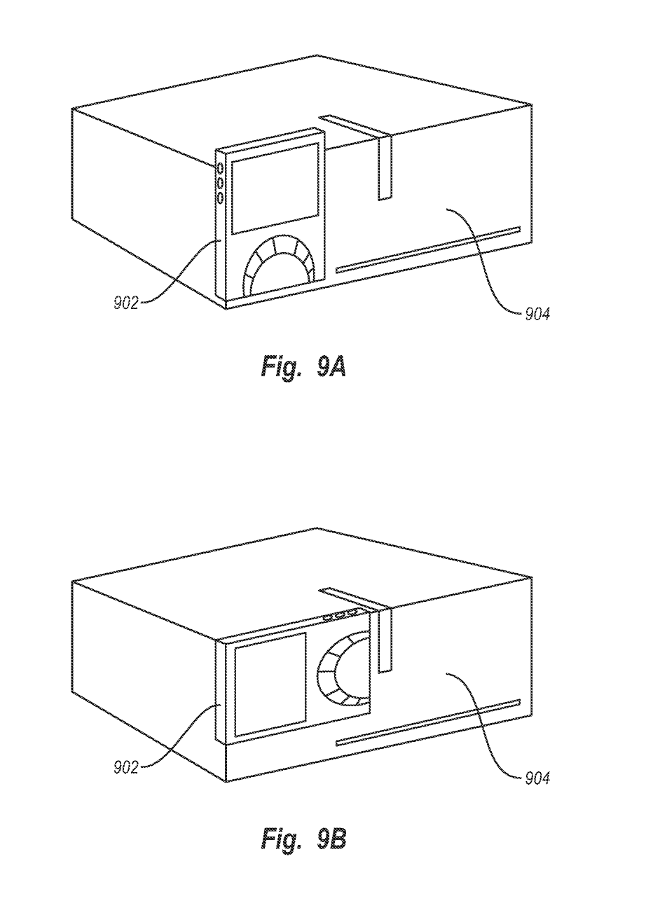

FIGS. 9A and 9B illustrate perspective views of other embodiments of a portable media device 902 that interfaces with another embodiment of a peripheral media device 904. The peripheral media device 904 may be a device such as a computer, or may be a docking station, including speakers, for the portable media device 902. As illustrated in FIGS. 9A and 9B, the portable media device 902 can connect in various ways with the peripheral media device 904.

Those skilled in the art will appreciate that aspects of the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired and wireless links) through a communications network. In a distributed computing environment, program modules may be located in both local and remote memory storage devices.

An example system for implementing the invention includes a general purpose computing device in the form of a conventional computer, including a processing unit, a system memory, and a system that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system (BIOS), containing the basic routines that help transfer information between elements within the computer, such as during start-up, may be stored in ROM or some other non-volatile type of memory.

Embodiments of the portable media device and the peripheral media device may include computer-readable media for carrying or having computer-executable instructions or data structures stored thereon. Such computer-readable media can be any available media that can be accessed by a portable device or general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a portable device or general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

Although not required, the invention may be described in the general context of computer-executable instructions, such as program modules, being executed by computers in network environments. Generally, program modules include acts, routines, programs, objects, components, data structures, etc. that perform particular tasks or implement particular abstract data types. Computer-executable instructions, associated data structures, and program modules represent examples of the program code means for executing acts of the methods disclosed herein. The particular sequence of such executable instructions or associated data structures represents examples of corresponding acts for implementing the functions described in such acts.

The devices may also include a magnetic hard disk drive for reading from and writing to a magnetic hard disk, a magnetic disk drive for reading from or writing to a removable magnetic disk, or an optical disk drive 108 for reading from or writing to removable optical disk such as a CD-ROM or other optical media. The drives and their associated computer-readable media provide nonvolatile storage of computer-executable instructions, data structures, program modules and other data. Although the exemplary environment described herein may employ a magnetic hard disk, a removable magnetic disk and/or a removable optical disk, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk, magnetic disk, optical disk, ROM or RAM, including an operating system, one or more application programs, other program modules, and program data. A user may enter commands and information through a keyboard, pointing device, or other input devices (not shown), such as a microphone, joy stick, touch pad, game pad, satellite dish, scanner, or the like. These and other input devices are often connected to the processing unit through a universal serial bus (USB) or serial port interface coupled to system bus. Alternatively, the input devices may be connected by other interfaces, such as a parallel port, or a game port. A display device is also connected to system bus via an interface, such as video adapter.

The computer may operate in a networked environment using logical connections to one or more remote computers, such as remote computers. The remote computers may each be another personal computer, a server, a router, a network PC, a peer device or other common network node, and typically include many or all of the elements described above relative to the computer. The logical connections may include a local area network (LAN) and a wide area network (WAN), by way of example only. Such networking environments are commonplace in office-wide or enterprise-wide computer networks, intranets and the Internet.

When used in a LAN networking environment, the computer is connected to the local network through a network interface or adapter. When used in a WAN networking environment, the computer may include a modem, a wireless link, or other means for establishing communications over the wide area network, such as the Internet. The modem, which may be internal or external, is connected to the system bus via the serial port interface. In a networked environment, program modules depicted relative to the computer, or portions thereof, may be stored in the remote memory storage device. It will be appreciated that the network connections described are exemplary and other means of establishing communications over wide area network may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A personal media managing system, comprising:
a portable media device, the portable media device comprising:
an interactive control display;
memory for storing media; and
a media player module configured for playing selected media for a user; and
a peripheral media device configured for removable connectivity with the portable media device, the peripheral media device comprising:
a content management system for coordinating the upload to the peripheral media device of selected media from a media source and the upload to the portable media device of selected media from the peripheral media device; and
a mass storage device serving as a redundant backup of media from the portable media device and as a repository of media not currently stored on the portable media device.

2. A system as defined in claim 1, wherein the media source comprises an Internet source.

3. A system as defined in claim 1, further comprising an optical drive that is configured to automatically read media stored on optical media inserted into an optical drive bay corresponding to the optical drive and store the read media to the mass storage device.

4. A system as defined in claim 1, further comprising a content management system on each of the portable media device and the peripheral media device.

5. A system as defined in claim 1, wherein each of the portable media device and the peripheral media device comprise dock members that are configured for interfacing with one another to enable the sharing of content between the portable media device and the peripheral media device.

6. A system as defined in claim 5, wherein the act of interfacing the dock members initiates the automated transfer of content between the portable media device and the peripheral media device.

7. A system as defined in claim 1, wherein each of the portable media device and the peripheral media device comprise wireless systems that are configured for communicating with one another to enable the sharing of content between the portable media device and the peripheral media device.

8. A system as defined in claim 1, wherein the media player module comprises at least a satellite receiver system.

9. A system as defined in claim 1, wherein the peripheral media device further comprises a secure wireless system for wirelessly transmitting audio content to authorized devices for real time audio listening.

10. A system as defined in claim 9, wherein the secure wireless system transmits the audio content in at least one of a secure mode or an unsecure mode.

11. A peripheral media personal computing system, comprising:
a portable media device, the portable media device comprising:
a first dock member;
an interactive control display;
memory for storing media; and
a media player module configured for playing selected media to a user; and
a peripheral media device, comprising:
a content management system for coordinating the upload to the peripheral media device of selected media from a media source and the upload to the portable media device of selected media from the peripheral media device;
a second dock member for receiving the first dock member, wherein connecting the first dock member to the second dock member activates the personal media managing system such that automated data transfer is initiated; and
a mass storage device serving as a redundant backup of media from the portable media device and as a repository of media not currently stored on the portable media device.

12. A system as defined in claim 11, wherein the peripheral media device has no means of user control other than that provided by the portable media device.

13. A system as defined in claim 11, wherein the portable media device comprises a satellite radio receiver.

14. A system as defined in claim 11, further comprising one or more ports on the peripheral media device for receiving control devices for controlling the peripheral media device.

15. A system as defined in claim 11, wherein the peripheral media device further comprises an optical drive and is configured to automatically read media stored on optical media inserted into the optical drive and store the media to the mass storage device.

16. A system as defined in claim 11, wherein the peripheral media device further comprises a secure wireless system for wirelessly transmitting audio content to authorized devices for real time audio listening.

17. A peripheral media personal computing system, comprising:
a portable media device, the portable media device comprising:
a docking portion;
an interactive control display;
memory for storing media;
a media player module configured for playing selected media to a user;
a first content management system for managing transfer of media between the portable media device and a peripheral media device; and
the peripheral media device, comprising:
a second content management system for coordinating the upload to the peripheral media device of selected media from a media source and the upload to the portable media device of selected media from the peripheral media device;
a dock base for receiving the docking portion of the portable media device, wherein inserting the portable media device in the dock base activates the peripheral media personal computer such that automated data transfer is initiated;
a mass storage device serving as a redundant backup of data from the portable media device and as a repository of data to be uploaded to the portable media device; and
an optical drive that is configured to automatically read media stored on optical media inserted into the optical drive bay and store the read media to the mass storage device.

18. A system as defined in claim 17, wherein the media source comprises an Internet source.

19. A system as defined in claim 17, wherein the act of interfacing the docking portion to the dock base initiates the automated transfer of content between the portable media device and the peripheral media device.

20. A system as defined in claim 17, wherein the media player module comprises at least a satellite receiver system.

21. A system as defined in claim 17, wherein the peripheral media device further comprises a secure wireless system for wirelessly transmitting audio content to authorized devices for real time audio listening.

22. A system as defined in claim 17, wherein the optical drive comprises a holographic drive.
